(19) United States
(12) Patent Application Publication
(10) Pub. No.: US 2007/0070597 A1
(43) Pub. Date: Mar. 29, 2007

(54) Uni-Body Power Tool

(76) Inventors: David B. Fisher, Bowling Green, KY (US); David E. Champlin, (US)

Correspondence Address: MIDDLETON & REUTLINGER, 2500 BROWN & WILLIAMSON TOWER, LOUISVILLE, KY, 40202, US

(21) Appl. No.: 11/463,246

(22) Filed: Aug. 8, 2006

Related U.S. Application Data
(62) Division of application No. 11/220,260, filed on Sep. 6, 2005.

(51) Int. Cl. G06F 1/16

(52) U.S. Cl. 361/685

(57) ABSTRACT

An electrically powered tool comprises a unitary chassis and a novel strain relief system incorporating a molded housing having a bore therein for securing power wiring to said chassis and preventing stress thereto.

### FIELD OF THE INVENTION

The present invention relates generally to electric power operated hand tools and specifically to a chainsaw having a unitary chassis design for stability, rigidity and ease of assembly, an improved chain bar retaining system and improved strain relief for electrical wiring supplying power to the chainsaw motor.

### BACKGROUND OF THE INVENTION

Lightweight and portable power tools have become popular consumer items as the number of people who own and maintain their own homes has grown over the past decades. Specifically, lightweight electrically powered chainsaws and other electrical power tools have proliferated due to the need for light tree and branch trimming and the widespread commercialization of consumer-grade saws. Electrically powered saws are preferred by many consumers over conventional two-cycle motor type saws since they obviate the need for mixing oil and gas as required for most two-cycle systems, are much quieter to use, and are usually lighter in weight.

Most conventional power saws utilize a continuous loop-type chain driven by a drive sprocket secured to an end of a rotating shaft, which is in turn driven by an electric motor or alternatively an internal combustion engine. The chain travels along a groove in the perimeter of an elongated guide bar having one end secured to the saw proximate the drive sprocket.

Many prior art chain saws utilize guide bars that are secured to a chassis or plate securely mounted within the saw assembly. Guide bars are required to be capable of motion along their longitudinal axis to enable proper tensioning of the chair that rotates around the perimeter of the guide bar. As the saw is used the chain necessarily stretches to a certain degree, thereby causing a loose fit between the rotating chain and the guide bar. When this fit becomes too loose it poses a danger to a user since a rapidly moving chain may “jump” off the guide bar.

Accordingly, a wide variety of chain tensioning systems have been implemented in the prior art. Most of these systems involve moving or biasing the guide bar forward, away from the drive sprocket along its longitudinal axis thereby taking up any slack in a loose chain. To effect motion of this type, guide bars typically comprise a slotted portion that is placed over a pair of threaded posts that protrude outwardly from the chainsaw having one end secured to the chassis, and one end free to accept a nut having complementary threads. The nuts are then tightened down against the guide bar to hold it securely to the chassis. An example of such a system is shown in U.S. Pat. No. 5,353,506 to Müller et al.

In the aforementioned prior art systems it is difficult for one person to adjust chain tension since one or more screws or bolts must be loosened, the guide bar must be biased into the proper position and held there, then the screws or bolts must be tightened while holding the guide bar in place. This operation often requires more dexterity than most users possess.

A further difficulty with prior art power tool systems that operate on electrical power is the tendency of the necessary cord carrying electrical power to the tool via electrical conductors to suffer failure due to strain from repetitive use or even a catastrophic single event. Obviously the failure of an electrical cord or cords can be quite dangerous to the user and those in the immediate vicinity. Specifically, many cord assemblies fail at the point where they enter the power tool, since this point is subject to a great deal of flexing and twisting. Accordingly, many manufacturers have developed strain relief systems to protect electrical conductors enclosed therein from damage.

Various standards have been developed to guide manufacturers in the proper design of power cords and their concomitant strain relief systems. ANSI requirements and those requirements promulgated by organizations such as UL and CSA for alternating current powered products aid manufacturers in developing integrity in the power cord and its retention within the tool.

Typically, prior art strain relief devices comprise power wiring encapsulated within a molded portion that is then captured between two halves of the tool housing, and held in place by compressive force as the housing halves are held together with fasteners or adhesives. These molded portions often employ various and sundry flanges or grooves that engage slots or protrusions in the housing halves to retain the strain relief

One difficulty with prior art strain relief systems is that the strain relief is typically integrally molded to the power cord using relatively soft, elastic material that is thence captured by relatively hard, inflexible molded housings. The use of these materials makes consistent strain relief/housing mating difficult, since much of the fit is dependent on production tooling wear, molding peculiarities and the like. Accordingly, there is a need for a robust strain relief system for a power tool that minimizes production material and labor costs while maximizing system integrity over a wide variety of manufacturing platforms.

Finally, many commercially available power tools utilize a “split-case” design for housing and protecting the tool motor and power components wherein the motor is disposed and secured in a first half and, in the case of a chainsaw, the sprocket and cover are disposed in a second, mating half. The two halves are usually molded from a high impact plastic and have complimentary fasteners such as slots and tabs to secure to halves together, typically along a central longitudinal seam.

One difficulty with these prior art tool designs is that the two cover halves are prone to breaking apart along the seam when the tool is subjected to a sharp impact, such as from being dropped or struck. Furthermore, these split case designs require a large amount of production tooling and high labor cost to assemble since their designs are relatively complex. Accordingly, there is a need in the art for a power tool having a design that obviates the disadvantages inherent in conventional split-case designs.

### SUMMARY OF THE INVENTION

In order to obviate the above-mentioned problems, a power tool is provided that utilizes a unitary housing construction wherein a single unitary chassis is provided for the mounting of various components that acts to both enhance the overall strength and rigidity of the tool as well as reduce manufacturing costs.

Furthermore, the present invention incorporates a novel guide bar design for use in conjunction with a chainsaw power tool embodiment that provides for positive and facile retention of the guide bar to the chainsaw as well as a convenient mechanism for adjusting chain tension. The retention system incorporates a mounting pin and a keyed retaining pin, both of which engage apertures or a slot in a guide bar wherein the guide bar is compressively engaged by simple rotational motion of the retaining pin.

The present invention further comprises an electrically operated power tool having a novel strain relief system that employs an integrally molded relief cord having a central aperture or bore for routing power wiring, wherein the strain relief bore is advantageously engaged by a protruding post or pin of the power tool thereby enabling use of the strain relief with a wide variety of electrical devices and in a wide variety of strain relief applications.

Other features, objects and advantages of the present invention will become apparent from reading the detailed description of the preferred embodiments taken in conjunction with the attached drawing Figures.

### BRIEF DESCRIPTION OF THE DRAWING FIGURES

FIG. 1 is a left side view of an electric chain saw power tool in accordance with one embodiment of the present invention.

FIG. 2 is a right side view of an electric chain saw power tool in accordance with one embodiment of the present invention.

FIG. 3 is a right side view of an electric chain saw power tool in accordance with one embodiment of the present invention.

FIG. 4 is a bottom view of an electric chain saw power tool in accordance with one embodiment of the present invention.

FIG. 5 is a front view of an electric chain saw power tool in accordance with one embodiment of the present invention.

FIG. 6 is a rear view of an electric chain saw power tool in accordance with one embodiment of the present invention.

FIG. 7 is a detail view of a guide bar retention system shown from the right side of the chainsaw in accordance with one embodiment of the present invention.

FIG. 8 is a detail view of a guide bar retention system shown from the right side of the chainsaw in accordance with one embodiment of the present invention.

FIG. 9 is an isometric view of a retaining pin in accordance with one embodiment of the present invention.

FIG. 10 is a detail view of a guide bar retention system shown from the left side of the chainsaw in accordance with one embodiment of the present invention.

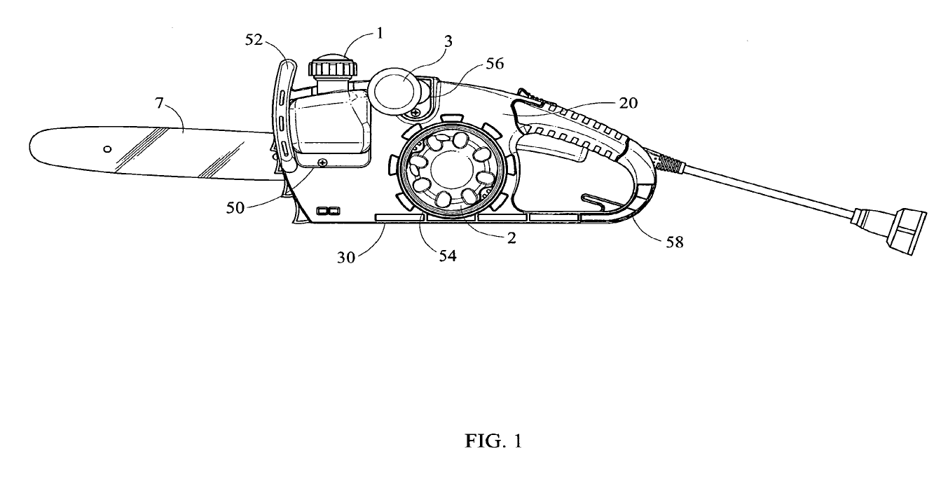

FIG. 1 is a schematic view of a strain relief system in accordance with one embodiment of the present invention.

FIG. 12 is a partial cross-sectional view of a strain relief system taken along the line 12-12 in accordance with one embodiment of the present invention.

FIG. 13 is a side view of a strain relief system in accordance with one embodiment of the present invention.

FIG. 14 is a side view of a strain relief system installed in a power tool in accordance with one embodiment of the present invention.

### DETAILED DESCRIPTION OF THE PREFERRED EMBODIMENT(S)

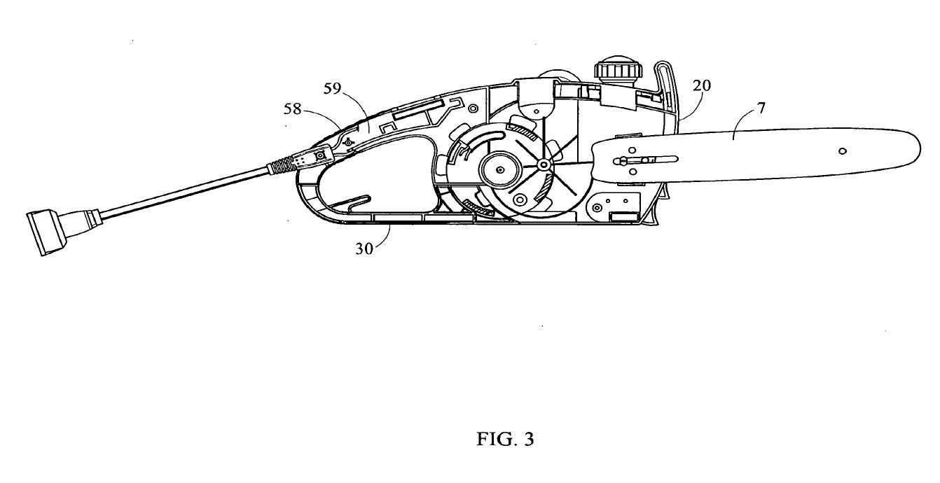

Referring now to FIG. 1, and in accordance with a preferred constructed embodiment of the present invention, a power tool 10 comprises a unitary chassis 20 having a plurality of attachment points 22 for securing necessary components of power tool 10 thereto. Unitary chassis 20 may comprise a central longitudinal member 30 for strength and rigidity along a portion thereof as seen in FIGS. 1 and 3.

The unitary chassis 20 of the present invention may be molded from, for example, a high impact plastic compound such as polyethylene, polycarbonate, nylon, or the equivalent thereof having integrally molded attachment points 22 to which necessary tool components are mounted. For purposes of this specification reference will be made to an electric chain saw power tool 10. However, one of ordinary skill in the art will recognize that the present invention may be utilized in a wide variety of applications and is not limited to the environment of a chainsaw.

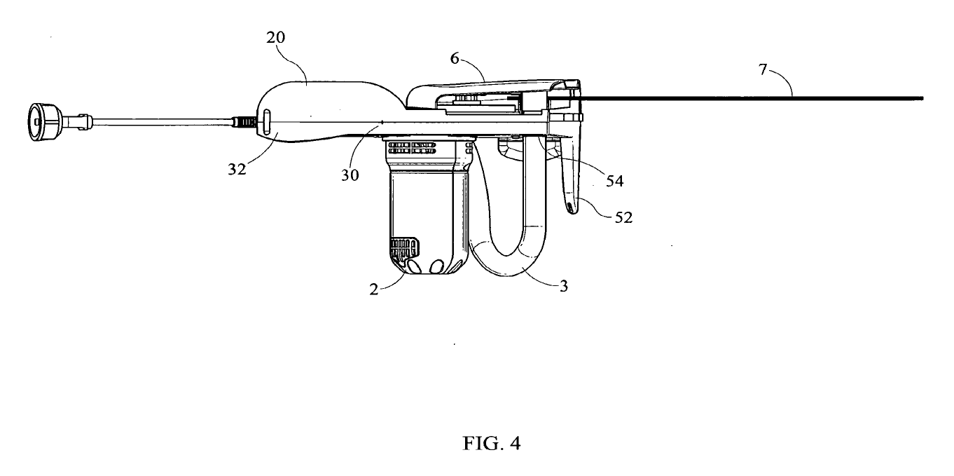

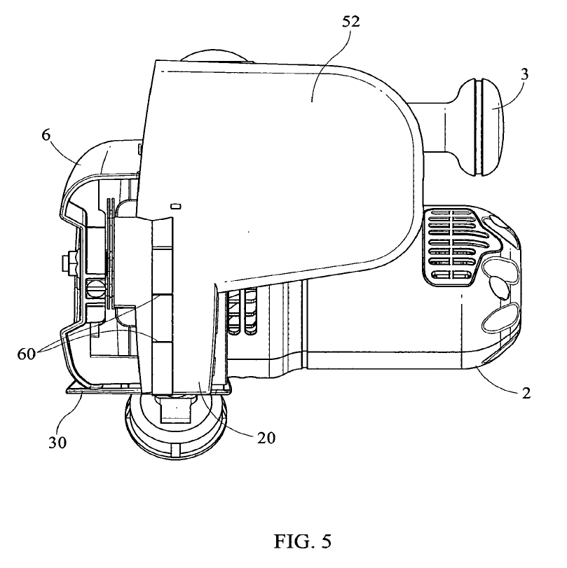

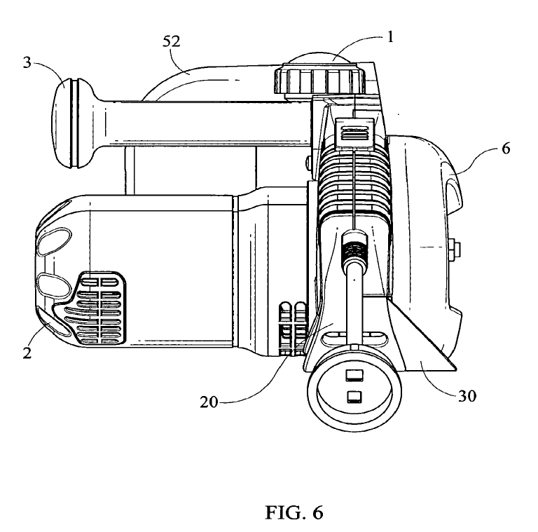

FIG. 1 is a left side view of unitary chassis 20 having attachment points 22 as necessary for an electrically operated chainsaw power tool. Chassis 20 includes a mounting aperture 50 shaped to accept an oil reservoir 1, an integrally molded hand back guard 52, a motor aperture 54 shaped to accept a suitable electric motor 2, and a handle mounting aperture 56 shaped to accept a handle 3 and to which handle 3 is secured via conventional fasteners. As best seen in FIGS. 4 and 5 and in accordance with an alternative embodiment of the instant invention, a u-shaped side handle 3 may be secured to the left side or motor side of chassis 20 at upper and lower mounting apertures 56 provided integrally to chassis 20.

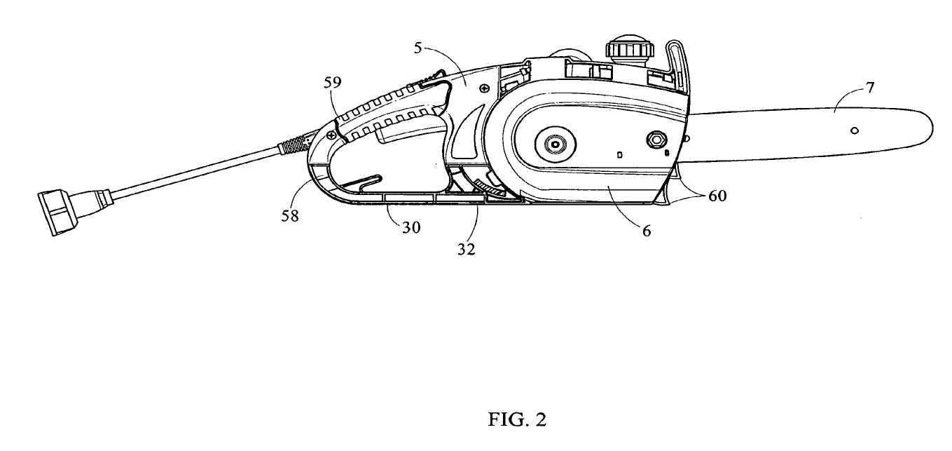

As seen in FIG. 2 the right side of chassis 20 further comprises an integral molded handle 58, said handle including an open portion 59 to facilitate the installation and routing of a power cord 4 assembly as will be discussed in greater detail herein below. A handle cover 5 shaped to mate with integral handle 58 may be installed to cover open portion 59 thereby obscuring and protecting power cord 4 and concomitant wiring to motor 2. Furthermore, a sprocket cover 6 is secured to one side of unitary chassis 20 to cover the rotating sprocket and gearing necessary to drive a chain (not shown) around the perimeter of guide bar 7.

Chassis 20 may further comprise a plurality of integrally molded bumper spikes 60 extending outwardly from a forward portion of chassis 20 proximate guide bar 7 to facilitate gripping a tree branch or other item being cut by the tool 10. This feature of the invention obviates the need to secure a separate bumper spike assembly to chassis 20 as is the case with prior art devices, thereby reducing assembly time and cost.

In one embodiment of the present invention unitary chassis 20 central member 30 may comprise an integrally molded I-beam that is disposed substantially the entire length of chassis 20 to provide enhanced rigidity thereto. I-beam shaped central member 30 may be molded such that a lower portion 32 thereof is disposed along and forms the bottom of chassis 20.

In a further embodiment of the present invention as shown in FIG. 2 the chassis 20 comprises a drive shaft aperture 64 through which a shaft of motor 2 passes when mounted in motor aperture 54. This feature of the present invention facilitates mounting and assembly of motor 2 in chassis 20 thereby reducing production cost and time. As is readily apparent from the drawing Figures and detailed description provided above, the unitary chassis 20 permits power tool 10 to be assembled by simply placing the requisite components into integral spaces specifically designed to accept their specific dimensions. Furthermore, the chassis 20 obviates the need for the design and construction of two separate case halves and the attendant cost and performance difficulties inherent thereto. Accordingly, the invention may accommodate the construction of a wide variety of power tools.

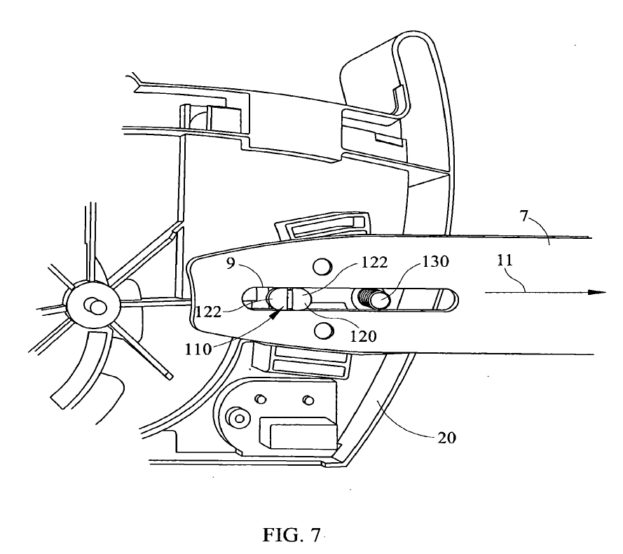

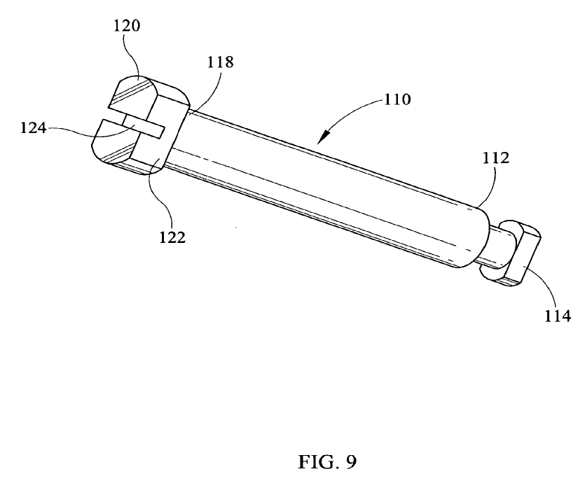

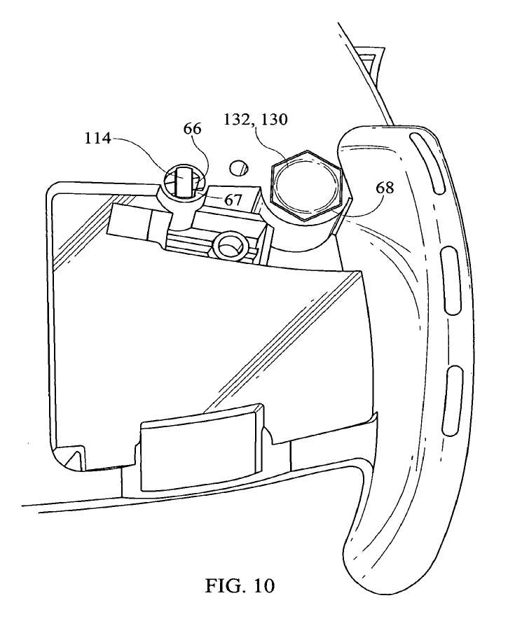

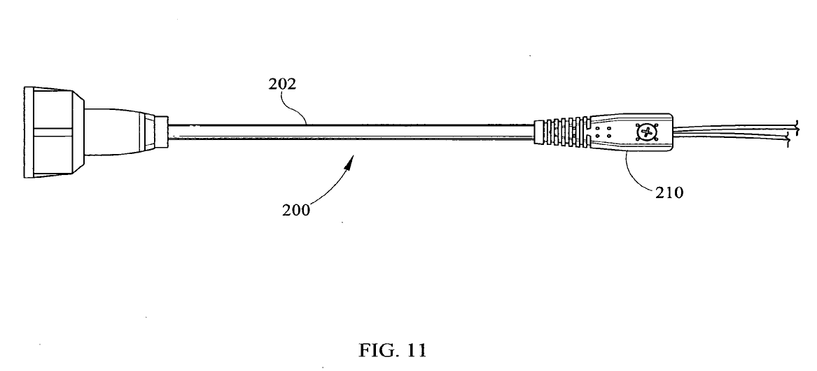

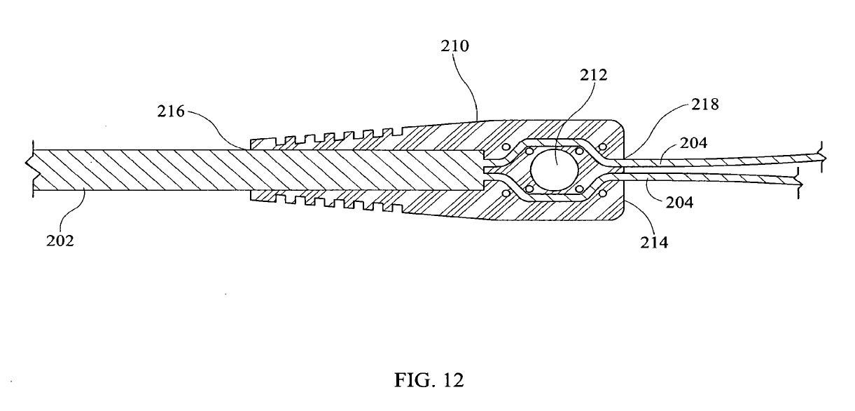

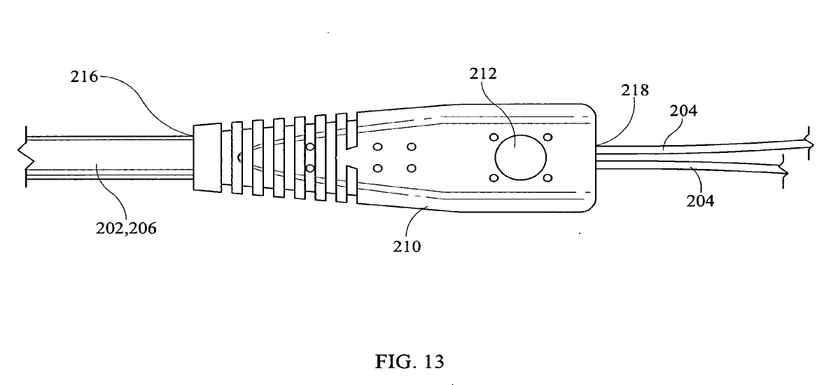

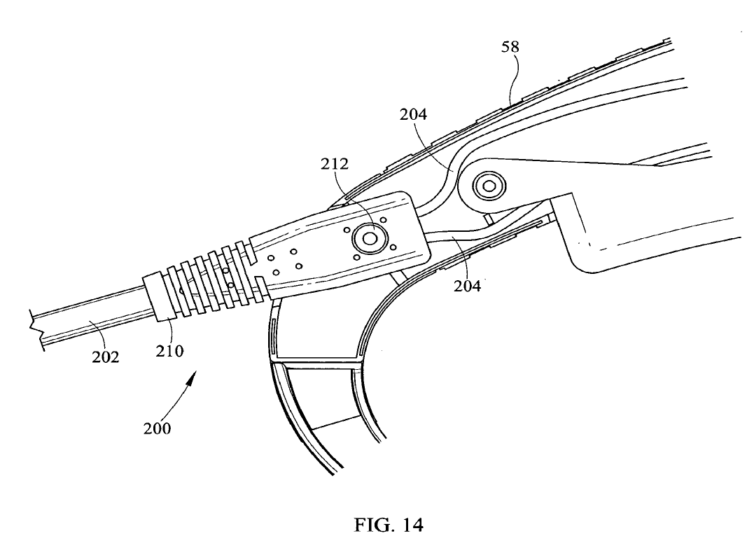

Referring now to drawing FIGS. 7-10 a retention system 100 for chainsaw guide bar 7 comprises a first retaining pin 110 having a first end 112 that is rotatably secured within a retaining pin key slot 66 disposed in chassis 20 on the side thereof opposite guide bar 7. First end 112 of retaining pin 110 may comprise a keyed end 114 that permits pin 110 to rotate while end 114 is prevented from passing through retaining pin key slot 66. Furthermore, as best seen in FIG. 10 retaining pin key slot 66 may include a stop 67 that protrudes inwardly into key slot 66 to prevent complete rotation of retaining pin 100. This feature of the invention allows keyed end 114 of retaining pin 110 to rotate ninety degrees either clockwise or counter-clockwise before a portion of keyed end 114 contacts stop 67. One of ordinary skill in the art will recognize that by providing an alternative shape to keyed end 114 the amount of rotation attainable before keyed end 114 contacts stop 67 may be customized.

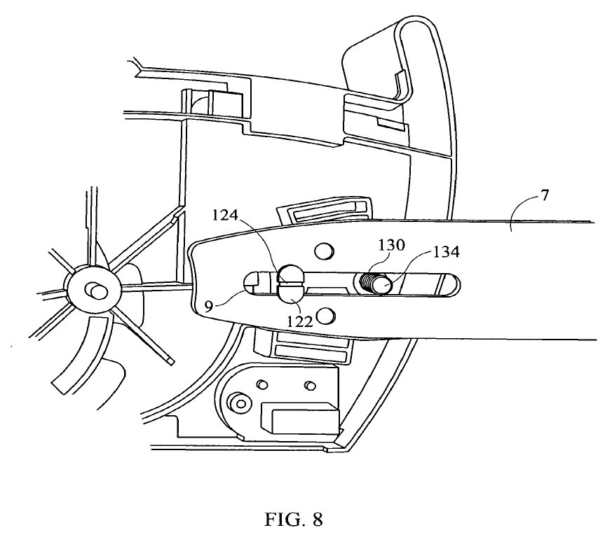

Retaining pin 110 further comprises a second end 118 having a flared head 120 thereon having wing portions 122 extending therefrom. Retaining pin 110 second end 118 is positioned to extends outwardly towards the guide bar 7 side of chassis 20. Wing portions 122 are shaped such that a slot 9 of guide bar 7 may be positioned over flared head 120 when pin 110 is rotated in a first direction, and such that when pin 110 is rotated in a second direction wing portions 122 rotate over the edges of slot 9 to contact the guide bar 7 proximate the slot 9 thereof, as best seen in FIG. 8.

Retaining pin 110 flared head 120 may further include a slot 124 therein to accept a conventional straight blade screwdriver or the like thereby permitting easy rotation of retaining pin 110. Additionally, wing portions 122 may be elongate in shape to permit them to be readily grasped and turned between the thumb and forefinger of a user. Additionally, retaining pin 110 has an overall length such that when rotated, the wing portions 122 engage guide bar 7 and compressively force it against chassis 20.

Retention system 100 further comprises a threaded mounting pin 130 capable of accepting a bolt or the like having complementary threads. A first end 132 of mounting pin 130 is disposed in a mounting pin aperture 68 in chassis 20. A second end 134 of mounting pin 130 extends out through the opposing side of chassis 20. The first end 132 of mounting pin 130 is hexagonal in shape and is designed to fit securely within mounting pin aperture 68 to prevent rotation of mounting pin 130 once installed. Accordingly, mounting pin aperture 68 may also be hexagonal in shape and sized to accept first end 132 of mounting pin 130 thereby preventing its rotation.

Mounting pin 130 has a diameter that permits slot 9 of guide bar 7 to pass over pin 130 such that a nut (not shown) may be secured over second end 134 thence tightened to secure guide bar 7 in place against chassis 20. Furthermore, mounting pin 130 may be spaced from retaining pin 110 along a central longitudinal axis as denoted by the arrow 11 in FIGS. 7 and 8.

In operation guide bar 7 must be periodically adjusted longitudinally in the direction of line 11 to account for the stretching of a chain that rotates around the perimeter of guide bar 7 or alternatively, the installation of a new chain. Retaining pin 110 is initially rotated such that wing portions 122 extending from flared head 120 are capable of passing through slot 9 of guide bar 7. The guide bar slot 9 is then placed over both the retaining pin 110 and the mounting pin 130 thereby permitting guide bar 7 to move longitudinally along pins 110 and 130. Guide bar 9 is thence moved longitudinally to a position where the desired chain tension is achieved.

Once guide bar 7 is satisfactorily positioned, retaining pin 110 is simply rotated into its second position either by inserting a screwdriver in slot 124 or by rotating wing portions 122 by hand, thereby permitting wing portions 122 to contact guide bar 7 proximate slot 9, forcing it against a portion of chassis 20 compressively. Since guide bar 7 is now held in place between wing portions 122 and chassis 20 the nut may be placed over second end 134 of mounting pin 130 and tightened. The retention system 100 of the present invention facilitates this operation by permitting a user to position guide bar 7 with one hand and then rotate retaining pin 110 with a second hand to retain guide bar 7 in place against chassis 20. The user then may release guide bar 7 and use both hands to secure a nut over mounting pin 130.

In an alternative embodiment of the present invention retaining pin 110 keyed end 114 is captured within key slot 66 such that pin 100 is not capable of rotational motion. In this embodiment of the invention flared end 120 of retaining pin 110 is rotatably secured to pin 110 such that it is capable of rotation independent of retaining pin 110. This embodiment of the invention permits the retaining pin 110 to be securely gripped by key slot 66 while permitting its flared end 120 to rotate freely to engage or disengage slot 9 of guide bar 7 as required.

Referring now to drawing FIGS. 11-14, a strain relief system 200 to protect power wiring 202 of a power tool 10 from stress due to flexing, twisting and longitudinal forces comprises an integrally molded housing 210 having a bore 212 that extends completely therethrough. The integrally molded housing 210 may be formed of many known in the art non-conductive, flexible, high strength materials such as any number of commercially available high-impact plastics.

As best seen in FIG. 11, bore 212 can be oriented centrally in housing 210, generally orthogonally to the direction of power wiring 202 although it should be noted that bore 212 may be oriented at a plurality of angles with respect to the power wiring 202 and in a plurality of locations within housing 210. The individual conductors 204 comprising power wiring 202 are routed around central bore 212 inside molded housing 210 before exiting a forward portion 214 of molded housing 210 and routed to a termination point within power tool 10. In power wiring systems having a plurality of conductors 204, a portion thereof may be routed over central bore 212 while the remainder may be routed under the central bore.

Molded housing 210 may further comprise a first aperture 216 into which power wiring 202 entering housing 210 is routed and at least one second aperture 218 through which power wiring 202 exiting housing 210 passes. Entering power wiring 202 may include a flexible exterior insulator 206 that is integrally molded into housing 210 such that the wiring contained within housing 210 simply forms an integral part thereof until exiting from forward portion 214.

As seen in FIG. 14 central bore 212 is sized to be positioned over a post 70 or equivalent pin or protrusion that is interior to power tool 10. In the present example, post 70 is shown as an integrally molded component of chassis 20, protruding from open portion 59 of integral handle 58. However, one of ordinary skill in the art will recognize that post 70 may be disposed at any location or orientation within a power tool 10 where it is desirable to route and secure power wiring 202.

Once central bore 212 is positioned over post 70 handle cover 5 is secured to integral handle 58 thereby capturing central bore 212 on post 70 and prohibiting longitudinal or side-to-side movement of molded housing 210. It should be noted that integral handle 58 and handle cover 5 may be shaped to facilitate entry of housing 210 into handle 58 once cover 4 is in place. In operation, since central bore 212 is captured on post 70 power wiring 202 is prevented from any longitudinal or twisting motion, and may only slightly flex upwardly or downwardly as permitted by the forward portion of housing 210 contacting interior portions of integral handle 58. Thus the present invention provides a strain relief system 200 which is vastly superior to prior art systems and simply will not permit twisting or longitudinal motion of power wiring, up to the structural tolerances of housing 210, post 70 and handle 58.

While the present invention has been shown and described herein in what are considered to be the preferred embodiments thereof, illustrating the results and advantages over the prior art obtained through the present invention, the invention is not limited to those specific embodiments. The forms of the invention shown and described herein are to be taken as illustrative only and other embodiments may be selected without departing from the scope of the present invention, as set forth in the claims appended hereto.

1-8. (canceled)

9. A modular power tool comprising:
a unitary chassis formed of a single piece of material having a plurality of attachment points integral thereto for attaching components, and a motor aperture therein shaped to accept a motor; and
a motor secured to said unitary chassis on a first side thereof in said motor aperture for supplying power to said tool.

10. A modular power tool as claimed in claim 9 wherein said unitary chassis comprises an integral handle for holding said tool.

11. A modular power tool as claimed in claim 9 further comprising a handle secured to said chassis at an attachment point wherein said attachment point is shaped to accept said handle.

12. A modular power tool as claimed in claim 9 wherein said unitary chassis further comprises a plurality of bumper spikes protruding therefrom at a forward portion of said chassis.

13. A modular power tool as claimed in claim 9 wherein said unitary chassis further comprises an oil reservoir aperture for securing an oil reservoir thereto.

14. A modular power tool as claimed in claim 9 wherein said unitary chassis further comprises an integral hand guard depending from a forward portion of said chassis.

15. A modular power tool as claimed in claim 9 wherein said unitary chassis comprises an I-beam shaped portion disposed longitudinally therein along substantially the entire length of said chassis.

16. A modular power tool as claimed in claim 9 wherein said unitary chassis comprises an integral I-beam shaped portion disposed along a bottom portion of said chassis.

17. A modular power tool as claimed in claim 9 wherein said unitary chassis is comprised of high impact plastic.

18-23. (canceled)
